(19) United States
(12) Patent Application Publication
(10) Pub. No.: US 2011/0289148 A1
(43) Pub. Date: Nov. 24, 2011

(54) METHOD AND APPARATUS FOR ASSIGNING A CONTROL ROLE FOR A COLLABORATIVE COMMUNICATION SESSION, AND METHOD AND APPARATUS FOR REQUESTING A CONTROL ROLE FOR A COLLABORATIVE COMMUNICATION SESSION

(75) Inventor: Frank Kowalewski, Goettingen (DE)

(73) Assignee: INTEL MOBILE COMMUNICATIONS TECHNOLOGY GMBH, Neubiberg (DE)

(21) Appl. No.: 13/091,177

(22) Filed: Apr. 21, 2011

Related U.S. Application Data
(60) Provisional application No. 61/327,138, filed on Apr. 23, 2010.

(30) Foreign Application Priority Data
Apr. 22, 2010 (DE) 10 2010 017 926.4

(51) Int. Cl. G06F 15/16

(52) U.S. Cl. 709/205

(57) ABSTRACT

In a method for assigning a control role for a collaborative communication session, a message is received which indicates, independently of a media transfer request for a collaborative communication session, that a control role for the collaborative communication session is intended to be assigned to at least one terminal which is specified by the message as a holder of a control role, and a control role for the collaborative communication session is assigned to the at least one terminal which is specified by the message as the holder of a control role. In a method for requesting a control role for a collaborative communication session, a message which corresponds to the received message is sent. The methods are carried out by appropriately designed apparatuses.

The invention relates to a method and an apparatus for assigning a control role for a collaborative communication session, and to a method and an apparatus for requesting a control role for a collaborative communication session.

Communication by technical means between a specific finite number of subscribers is referred to as a communication session. A collaborative communication session is communication being carried out using a plurality of communication terminals (also referred to for short in the following text as terminals) for a single one of the communication ends. In other words, at least one of the communication ends (that is to say one of the subscribers) uses a plurality of terminals in order to communicate with at least one other communication end. One terminal at one communication end controls the collaborative session, for example by determining which communication media (for example audio, video, text, etc.) are intended to be transmitted to which terminals for the collaborative session, holding a so-called control role.

In order to allow the functions of controlling terminals in a collaborative communication session only for the controlling terminal (and in particular not to allow those terminals which are not carrying out a controlling function to do so), it is necessary to be able to allocate the controlling role (in other words: to assign) for one terminal in the communication system.

It is known from the document “3GPP Technical Specification TS23.237, V9.2.0, IP Multimedia Subsystem (IMS) Service Continuity; Stage 2” that a communication system designed in accordance with the Internet Protocol Multimedia Subsystem (IMS) of the 3GPP mobile radio standard can be used to carry out collaborative communication sessions.

During IMS collaborative communication sessions, a user is registered with a plurality of terminals on the IMS. The collaborative session is set up by one of the terminals requesting the IMS to transfer one of its communication media to another terminal of the user. This means that, after the media transfer, the medium is no longer received by the first communication terminal, but by the other communication terminal. In this case, the terminal requesting this media transfer is assigned the control role for the collaborative session.

It will be desirable to allow the control role to be assigned in a more flexible manner.

The problem is solved by the method and the apparatuses as claimed in the respective independent patent claims.

In a method for assigning a control role for a collaborative communication session, a message is received which indicates, independently of a media transfer request for a collaborative communication session, that a control role for the collaborative communication session is intended to be assigned to at least one terminal, which is specified by the message as a holder of a control role, and a control role for the collaborative communication session is assigned to the at least one terminal which is specified by the message as the holder of a control role.

An apparatus for assignment of a control role for a collaborative communication session has a receiving unit which is designed for reception of a message which indicates, independently of a media transfer request for a collaborative communication session, that a control role for the collaborative communication session is intended to be assigned to at least one terminal which is specified by the message as a holder of a control role, and it has an assignment unit, which is designed for assignment of a control role for the collaborative communication session to the at least one terminal which is specified by the message as the holder of a control role.

In a method for requesting a control role for a collaborative communication session, a message is transmitted which indicates, independently of a media transfer request for a collaborative communication session, that a control role for the collaborative communication session is intended to be assigned to at least one terminal which is specified by the message as the holder of a control role.

An apparatus for requesting a control role for a collaborative communication session has a request unit which is designed to transmit a message which indicates, independently of a media transfer request for a collaborative communication session, that a control role for the collaborative communication session is intended to be assigned to at least one terminal which is specified by the message as the holder of a control role.

The invention allows the control role to be assigned in a more flexible manner.

In particular, the invention also has the advantageous effect that, even if a controlling terminal has already been assigned, it is possible to request and to assign the control role to an additional communication terminal, or the control roles to a plurality of additional communication terminals.

Furthermore, this results in the advantageous effect that the messages required to request a control role are relatively short, that is to say they require little signaling effort. Furthermore, this results in the advantageous effect that the control role is signaled directly.

In addition, the invention has the advantageous effect that complete control role administration is made possible with the aid of differential requests. This makes it possible to further reduce the size of the request messages.

Further exemplary embodiments of the invention are specified in the dependent patent claims and in the following description. In this case, where applicable, the explanations relating to the methods also apply in the same sense to the apparatuses, and vice versa.

According to one exemplary embodiment of the invention, the message is received by a server in a communication system, and the control role is assigned by a server in the communication system.

According to one exemplary embodiment of the invention, the message is transmitted by a terminal.

According to one exemplary embodiment of the invention, that terminal which transmits the message is designed for access to a communication system, and the message is transmitted to a server in the communication system.

According to one exemplary embodiment of the invention, the communication system to whose server the message is transmitted or by whose server the message is received is a communication system designed in accordance with the Internet Protocol Multimedia Subsystem (IMS) of the 3GPP mobile radio standard.

According to one exemplary embodiment of the invention, that terminal which transmits the message is not specified by the message as the holder of a control role. In other words, control roles can be requested by an appliance other than one of the desired controlling terminals. This makes it possible, for example, for a controlling terminal to request the control role for a non-controlling terminal. This has the advantageous effect that the control role for a terminal can also be requested by a device other than the desired controlling device.

According to one exemplary embodiment of the invention, a plurality of terminals are specified by the received message as holders of a control role. In other words, it is possible to receive a request for control roles for a plurality of terminals. This makes it possible to allocate the control role to a plurality of terminals for a collaborative session. This has the advantageous effect that a plurality of terminals may have the control role for the collaborative session.

According to one exemplary embodiment of the invention, a plurality of terminals are specified by the transmitted message as holders of a control role. In other words, it is possible to transmit a request for control roles for a plurality of terminals. This makes it possible to allocate the control role to a plurality of terminals for one collaborative session.

According to one exemplary embodiment of the invention, the message which is sent or received is a message in accordance with the Session Initiation Protocol (SIP). This has the advantageous effect that already existing message types, specifically existing SIP message types, can be used to request a control role assignment or a control role transfer. An SIP INFO message can be used to request control roles. A list of one or more communication terminal addresses for which a control role is requested is specified in the SIP INFO message.

According to one exemplary embodiment of the invention, the at least one terminal which is specified by the message that has been sent or received as the holder of a control role is specified in that it is specifically identified one of a plurality of terminals indicated in the message. In other words, it is possible to explicitly state that specific terminals among the terminals contained in the list which is contained in the message are intended to have a control role. Alternatively, it is possible to request a control role for all of the terminals contained in the list, without having to identify them any further.

According to one exemplary embodiment of the invention, a previously assigned control role for a terminal which is not specified by the message as a holder of a control role is ended for the collaborative communication session. In other words, within a request for the control role for one or more terminals, the withdrawal or the ending of the control role for this previously controlling terminal can be requested and implemented, by not requesting assignment of the control role for a previously controlled terminal. If, in this case, only one control role is requested for only one terminal, it is possible to allocate the control role in future only to one such terminal which previously did not hold the control role. This allows the control role to be transferred (shifted) from one terminal to another terminal. In this case, the first terminal loses its control role and the second terminal receives it. This has the advantageous effect that the request for a transfer of the control role from one terminal to another terminal and a corresponding assignment, are made possible that is to say with the control role being shifted from one terminal to another terminal.

According to one exemplary embodiment of the invention, a previously assigned control role for a terminal which is indicated by the message as a terminal which should not have a control role for the collaborative communication session is ended for the collaborative communication session. In other words, it is possible to explicitly state that specific terminals among the terminals contained in the list are not intended to have a control role.

According to one exemplary embodiment of the invention, before the assignment, a request is transmitted to a terminal which was previously assigned a control role for the collaborative communication session, as to whether the terminal which had previously been assigned a control role for the collaborative communication session authorizes the assignment. In other words, if one or more controlling terminals already exist in a collaborative session, it is possible, in the event of a control role request for another terminal, to ask one or more of the controlling terminals for authorization for the control role assignment. This has the advantageous effect that the authorization of the control role to be assigned for a terminal can be carried out by a controlling terminal.

Exemplary embodiments of the invention will be explained in more detail in the following text, and are illustrated in the figures, in which:

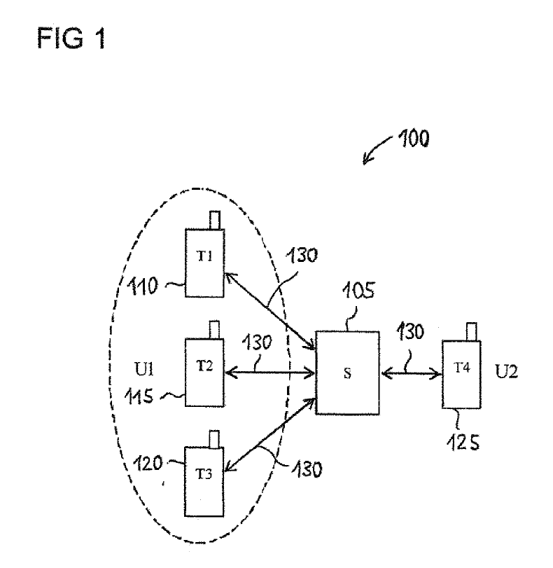

FIG. 1 shows an architecture, illustrated in a simplified form, of an IMS-based communication system;

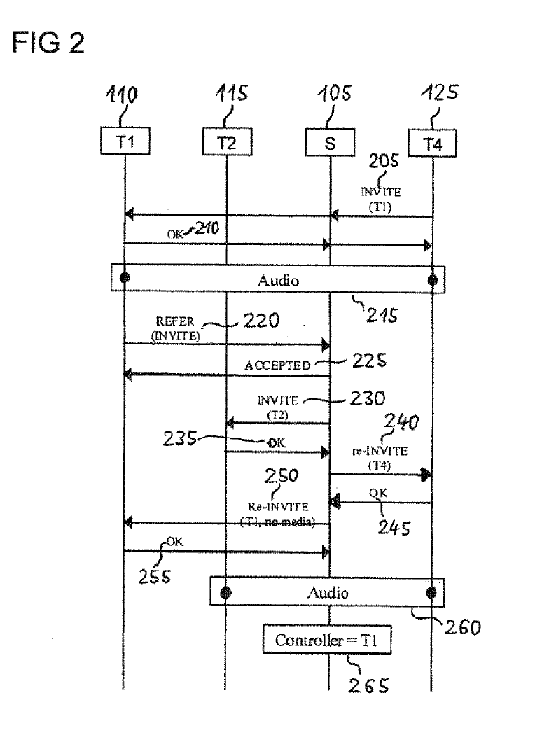

FIG. 2 shows a message flowchart, illustrating the message flow for media transfer within a collaborative session;

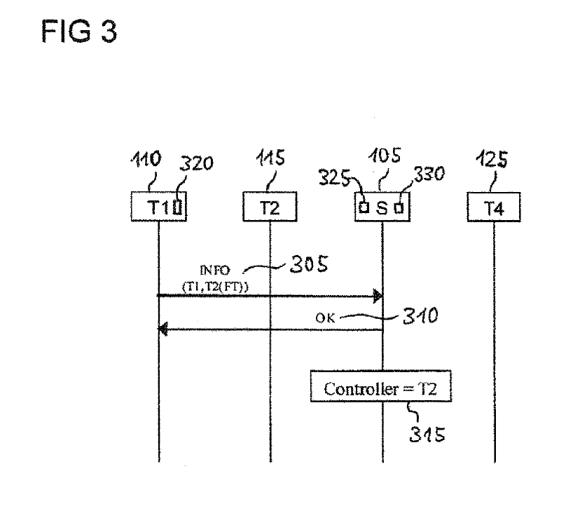

FIG. 3 shows a message flowchart, illustrating the message flow for transfer of the control role within a collaborative session, according to one exemplary embodiment of the invention;

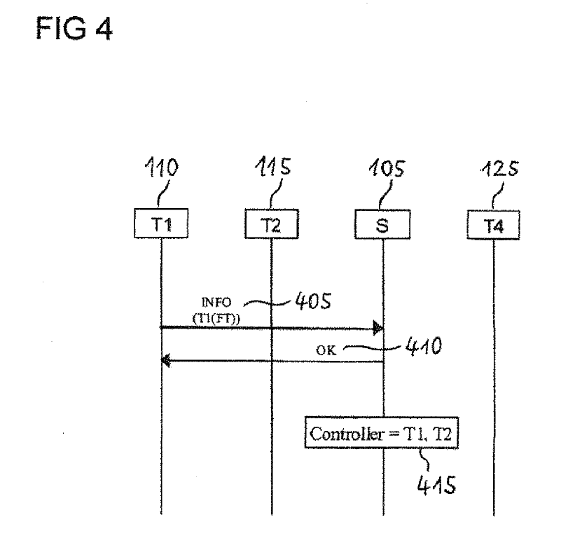

FIG. 4 shows a message flowchart, illustrating the message flow for adding a control role to an existing control role for a collaborative session, according to one exemplary embodiment of the invention; and

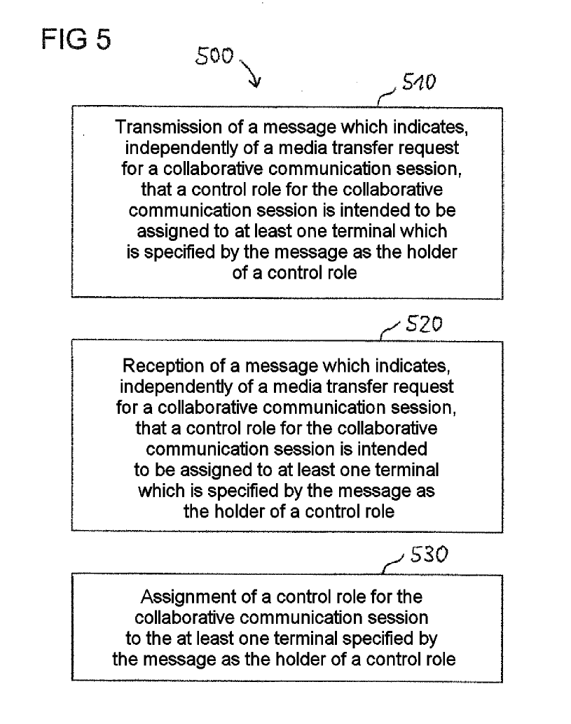

FIG. 5 shows a flowchart, illustrating a method for requesting a control role for a collaborative communication session, and a method for assignment of a control role for a collaborative communication session, according to exemplary embodiments of the invention.

For the purposes of this description, the terms “linked”, “connected” and “coupled” are used to describe both a direct and an indirect, link, a direct or an indirect connection and a direct or an indirect coupling. Identical or similar elements are provided with identical reference symbols in the figures, where this is expedient.

### Exemplary Embodiment 1

A communication system is considered which is based on the Internet Protocol Multimedia Subsystem (IMS) of the 3GPP mobile radio standard.

FIG. 1 shows an architecture, illustrated in simplified form, of an IMS-based communication system 100.

The communication system 100 consists of terminals and servers, to which the terminals are connected. In order to simplify the description, all relevant servers are referred to jointly as IMS servers 105 (S, server) in the following text. In actual systems, the IMS contains a multiplicity of servers with specific functionalities, for example call session control function servers, application servers, etc.

In the example, three communication terminals T1 110, T2 115 and T3 120 are allocated to one user U1. A further terminal T4 125 is allocated to the user U2. All the terminals are connected to the IMS server 105 and are registered with the server 105, as is symbolized by double-headed arrows 130.

The communication controlling in the IMS is carried out using the session initiation protocol (SIP). Communication session control messages can be requested by one communication device for another communication device by means of an SIP REFER message, that is to say a message of the REFER message type. In collaborative IMS sessions, SIP REFER messages are used to transfer media transmissions from one terminal to another terminal.

FIG. 2 shows a message flowchart illustrating the message flow for media transfer within a collaborative session for the IMS-based communication system 100 from FIG. 1.

With his terminal T4 125, the user U2 uses the SIP INVITE message 205, of the INVITE message type, to call the terminal T1 110 of the user U1. U1 accepts the call with his terminal T1 110 by means of the confirmation message OK 210. T1 is a stationary device (for example a computer). U1 wishes to leave the computer and therefore transfers the audio data for the communication with T4 125 from his computer T1 110 (previous audio link 215 between T1 and T4) to his mobile telephone T2 115.

T1 110 uses an SIP REFER message 220 to request the transfer of the media data from T1 110 to T2 115. The SIP REFER message 220 which is sent may appear as shown in the following Table 1 (the table shows only a small number of message fields which are relevant for the explanation in conjunction with the invention):

| | |
|---|---|
| Request-URI | S |
| SIP HEADERS | |
| To: | S |
| From: | T1 |
| Refer-to: | T2; method = INVITE |
| Contact: | T1 |

In this table, S is the SIP address of the IMS server 105, which is indicated here in the form of an Internet address, that is to say a Uniform Resource Identifier (URI). T1 and T2 are the SIP addresses of the subscriber terminals T1 110 and T2 115, respectively.

Server 105 accepts the media transfer request with the message ACCEPTED 225. With the INVITE message 230, the server 105 now invites T2 115 to join the audio communication, and T2 115 confirms this by the confirmation message OK 235. With the re-INVITE message 240, the server 105 then informs T4 125 of the new audio link, which T4 125 confirms by the confirmation message OK 245. With the re-INVITE message 250, the server 105 finally informs T1 110 that the media transfer has been completed, that is to say the original invitation to T1 has now been changed to an invitation without a media link, “no media”, which T1 110 confirms by the confirmation message OK 255.

The request for the media transfer by the terminal T1 110 results in a collaborative session with a new audio link 260 between T2 115 and T4 125. In “Controller=T1” 265 (control role holder=T1), T1 110 is assigned the control role for the collaborative session. This means, for example, that T1 110 can subsequently carry out further media transfers.

FIG. 3 shows a message flowchart illustrating the message flow for transfer of the control role within a collaborative session, according to one exemplary embodiment of the invention.

This starts from the situation at the end of the message flowchart in FIG. 2, that is to say a collaborative session exists with an audio link 260 between T2 115 and T4 125, with T1 110 having been assigned the control role for the collaborative session.

In order subsequently to allow media transfers to be controlled from his mobile telephone T2 115, the user U1 now wishes to transfer the control role for the terminal T1 110 to his mobile telephone T2 115.

According to the exemplary embodiment of the invention, T1 110 for this purpose sends an SIP INFO message 305, that is to say a message of the INFO message type, to the IMS server. The SIP INFO message 305 which is sent may appear as shown in the following Table 2 (the table shows only a small number of message fields which are relevant for the explanation in conjunction with the invention):

| | |
|---|---|
| Request-URI | S |
| SIP HEADERS | |
| To: | S |
| From: | T1 |
| Contact: | T1 |
| Content-Length: | . . . |
| Content-Type: | application/resource-lists+xml |
| Content: | . . . |
| | <resource-lists> |
| | . . . |
| | <list> |
| | <entry uri=“sip:T1”/> |
| | <entry uri=“sip:T2”> |
| | <feature-tag>g.3gpp.iut- |
| | controller</feature-tag> |
| | </entry> |
| | </list> |
| | </resource-lists> |

In this table, S is the SIP address of the IMS server 105, which is indicated here in the form of an Internet address, that is to say a Uniform Resource Identifier (URI). T1 and T2 are the SIP addresses of the subscriber terminals T1 110 and T2 115, respectively.

The message 305 contains an address list with the addresses T1 and T2. The entry for T2 in the address list is “g.3gpp.iut-controller”, which indicates a so-called feature tag “FT” or media feature tag. No feature tag “FT” is indicated for T1 in the message 305.

The message 305, specifically the entry “g.3gpp.iut-controller” therein, which is associated with T2, specifies the terminal T2 115 as the holder of a control role. The message 305 indicates that T2 115 should be assigned a control role for the collaborative communication session.

In contrast, the message 305 does not specify the terminal T1 110 to be the holder of a control role. Furthermore, although the message 305 mentions the terminal T1 110, it does not specify it as the holder of a control role, the message 305 in fact indicates the terminal T1 110 to be a terminal which is not intended to hold a control role for the collaborative communication session.

The IMS server 105 receives the SIP INFO message 305, and sees from the feature tag for T2 115 that T2 115 is now intended to hold the control role for the collaborative session. Since no feature tag is indicated for T1 110, the server 105 sees that T1 110 is no longer intended to hold the control role.

With the acknowledgement message OK 310, the server 105 accepts the request for control role assignment. In “Controller=T2” 315 (control role holder=T2), T2 115 is assigned the control role for the collaborative session. This means, for example, that T2 115 can subsequently carry out further media transfers.

The terminal T1 110 has a request unit 320 which is designed to transmit the message 305 which indicates that the intention is to assign a control role for the collaborative communication session to T2 115, which is specified by the message as being the holder of a control role.

The server 105 has a receiving unit 325, which is designed to receive the message 305, and it has an assignment unit 330, which is designed to assign the control role for the collaborative session to the terminal T2 115, which is specified in the message 305 as the holder of a control role.

### Exemplary Embodiment 2

FIG. 4 shows a message flowchart, in which the message flow is shown for addition of a control role to an existing control role for a collaborative session, according to one exemplary embodiment of the invention.

This example is based on the final situation from the first exemplary embodiment, that is to say on the situation at the end of the message flowchart in FIG. 3. A collaborative session therefore exists with an audio link 260 between T2 115 and T4 125 (the terminal T2 of the user U1 is communicating with the terminal T4 of the user U2). T2 115 has been assigned the control role for the collaborative session, with T2 115 being the only terminal of U1 which holds a control role for the collaborative session for U1.

U1 now returns to his computer T1 110, in order to work on it. In order to allow U1 to also control his collaborative session from T1 110, U1 now also wishes to assign the control role to T1 110, in addition to T2 115. U1 requests the assignment to T1 110.

For this purpose, according to the exemplary embodiment of the invention, T1 110 sends an SIP INFO message 405 to the IMS server 105. The SIP INFO message 405 which is sent may appear as shown in Table 3 below (the table shows only a small number of message fields which are relevant for the explanation in conjunction with the invention):

| | |
|---|---|
| Request-URI | S |
| SIP HEADERS | |
| To: | S |
| From: | T1 |
| Contact: | T1 |
| Content-Length: | . . . |
| Content-Type: | application/resource-lists+xml |
| Content: | . . . |
| | <resource-lists> |
| | . . . |
| | <list> |
| | <entry uri=“sip:T1”> |
| | <feature-tag>g.3gpp.iut- |
| | controller</feature-tag> |
| | </entry> |
| | </list> |
| | </resource-lists> |

In this table, S is the SIP address of the IMS server 105, which is indicated here in the form of an Internet address, that is to say a Uniform Resource Identifier (URI). T1 and T2 are the SIP addresses of the subscriber terminals T1 110 and T2 115, respectively.

In the Rubrik content and in the so-called BODY, the message 405 contains an address list with only the address of T1. The entry “g.3gpp.iut-controller” appears for T1 in the address list, indicating a so-called feature tag “FT” or media feature tag.

The message 405, specifically the entry “g.3gpp.iut-controller” therein, which is associated with T1, specifies the terminal T1 110 as the holder of a control role. The message 405 indicates that a control role for the collaborative communication session is intended to be assigned to T1 110.

In contrast, the message 305 does not specify the terminal T2 115 as the holder of a control role, and this is in fact not included at all in the address list in the message 305.

The IMS server 105 receives the SIP INFO message 405 and sees from the feature tag for T1 110 that T1 110 is now intended to hold the control role for the collaborative session.

Since T2 115 is not mentioned in the address list in the message 405, the server 105 sees that no change to the control role status should be made for T2 115, that is to say that T2 115 should retain the control role, and should therefore likewise hold this. In one alternative exemplary embodiment, the server 105 sees from this that T2 115 is not included in the address list in the message 405, that T2 115 is not intended to hold the control role, that is to say that the control role should now be withdrawn from T2 115, since it previously held one control role.

The server 105 uses the confirmation message OK 410 to accept the request for control role assignment. In “Controller=T1, T2” 415, both T1 110 and T2 115 are each assigned control roles for the collaborative session. In other words, in addition to the already existing control role for T2 115, T1 110 is now also assigned a control role for the collaborative session, in 415. For example, this means that both T1 110 and T2 115 can subsequently carry out further media transfers.

### Further Exemplary Embodiments

FIG. 5 illustrates a flowchart 500, showing a method for requesting a control role for a collaborative communication session and a method for assignment of a control role for a collaborative communication session, according to exemplary embodiments of the invention. The exemplary embodiments shown in FIG. 5 can be combined with all the other described exemplary embodiments of the respective method.

First of all, a method will be described for requesting a control role for a collaborative communication session according to one exemplary embodiment of the invention.

In 510, a message is sent which indicates, independently of a media transfer request for a collaborative communication session, that a control role for the collaborative communication session is intended to be assigned to at least one terminal which is specified by the message as the holder of a control role.

A method will now be described for assignment of a control role for a collaborative communication session, according to one exemplary embodiment of the invention:

In 520, a message is received which indicates, independently of a media transfer request for a collaborative communication session, that a control role for the collaborative communication session is intended to be assigned to at least one terminal which is specified by the message as the holder of a control role.

In 530, a control role for the collaborative communication session is assigned to the at least one terminal specified by the message as the holder of a control role.

In the overall analysis, 510, 520 and 530 show the interaction of the method for requesting a control role for a collaborative communication session and of the method for assignment of a control role for a collaborative communication session at the system level or overall network level.

According to one exemplary embodiment, the invention can also be applied to collaborative sessions which include the terminals of a plurality of users, that is to say in which a plurality of users with a plurality of terminals form one of the communication ends.

According to one exemplary embodiment, if a terminal in a collaborative session is not only involved in the collaborative session but is also carrying out further communication via the IMS server, a determination is made as to whether signaling is intended for the collaborative session, by comparing the so-called call-ID (call identification) of the SIP signaling with the call-ID for the collaborative session. If the call-ID for the SIP signaling matches the call-ID for the collaborative session, the signaling is associated with the collaborative session.

According to one exemplary embodiment, it is also possible to use an SIP MESSAGE, that is to say a message of the MESSAGE type (message, signal, SIP signaling message) instead of the SIP INFO message in order to request control roles for a collaborative session. The SIP MESSAGE then contains the list of terminal addresses in its body (message body).

According to one exemplary embodiment, appropriate SIP INFO messages which are in the form of a so-called SIP INFO package can be used instead of SIP INFO messages or SIP MESSAGES in order to request control roles. This is an extended message type “INFO”, for which SIP INFO packages can be defined.

Instead of having to insert the address list with terminals for the collaborative session directly into control role request messages, one exemplary embodiment allows a reference to an external address list to be inserted.

According to one exemplary embodiment, the IMS server can authorize the transfer of the control role. This is worthwhile in particular when a collaborative session includes the terminals of a plurality of users, and one of the users wishes to withdraw the control role from another user. The authorization can be implemented, for example, by checking existing controlling terminals for authorization permission. The controlling terminals can then check with their users for permission.

If the control role is requested for a single terminal, it is possible according to one exemplary embodiment for already existing control roles to be maintained. In other words, the terminal receives the control role, in addition to those terminals which already hold the control role.

If terminals in a collaborative session are not included in the address list of a control role request, one exemplary embodiment allows a possibly existing control role to be withdrawn from these terminals, instead of leaving their control role status unchanged.

According to one exemplary embodiment it is possible in principle, not to allocate feature tags for any of the addresses contained in the address list of a control role request. In this case, a control role is requested for all the terminals included in the list.

According to one exemplary embodiment, the invention can also be used if a different communication control protocol than SIP is being used, and/or if a different communication system than IMS is being used.

According to one exemplary embodiment of the invention, in a method for withdrawing a control role for a collaborative communication session, a message is received which specifies at least one terminal which holds a control role for a collaborative communication session not to be a holder of the control role for the collaborative communication session, and the control role is withdrawn from the at least one terminal which is specified as not being a holder of the control role for the collaborative communication session. It is possible for the message to specify the at least one terminal not to be a holder of the control role for the collaborative communication session, independently of a media transfer request for the collaborative communication session. The invention allows the control role to be withdrawn in a flexible manner. This exemplary embodiment can be combined with all the other exemplary embodiments of the invention.

According to one exemplary embodiment of the invention, in a method for requesting withdrawal of a control role for a collaborative communication session, a message is sent which specifies as a non-holder of the control role for the collaborative communication session at least one terminal which holds a control role for a collaborative communication session and from which the control role for the collaborative communication session is intended to be withdrawn. It is possible for the message to specify the at least one terminal as a non-holder of the control role for the collaborative communication session, independently of a media transfer request for the collaborative communication session. The invention allows the control role to be withdrawn in a flexible manner. This exemplary embodiment can be combined with all the other exemplary embodiments of the invention.

According to one exemplary embodiment of the invention, an apparatus for withdrawal of a control role for a collaborative communication session has a receiving unit which is designed to receive a message which specifies at least one terminal which holds a control role for a collaborative communication session as a non-holder of the control role for the collaborative communication session, and it has a withdrawal unit, which is designed to withdraw the control role from the at least one terminal which is specified as a non-holder of the control role for the collaborative communication session. It is possible for the message to specify the at least one terminal as a non-holder of the control role for the collaborative communication session, independently of a media transfer request for the collaborative communication session. The receiving unit can be formed by appropriately designing the receiving unit 325 illustrated in FIG. 3. The withdrawal unit can be formed by appropriately designing the assignment unit 330 illustrated in FIG. 3. The invention allows the control role to be withdrawn in a flexible manner. This exemplary embodiment can be combined with all the other exemplary embodiments of the invention.

According to one exemplary embodiment of the invention, an apparatus for requesting withdrawal of a control role for a collaborative communication session has a request unit which is designed to send a message which specifies at least one terminal which holds a control role for the collaborative communication session and from which the control role for the collaborative communication session is intended to be withdrawn as a non-holder of the control role for the collaborative communication session. It is possible for the message to specify the at least one terminal as a non-holder of the control role for the collaborative communication session, independently of a media transfer request for the collaborative communication session. The request unit can be formed by appropriately designing the request unit 320 illustrated in FIG. 3. The invention allows the control role to be withdrawn in a flexible manner. This exemplary embodiment can be combined with all the other exemplary embodiments of the invention.

1. A method for assigning a control role for a collaborative communication session, having:
reception of a message which indicates, independently of a media transfer request for a collaborative communication session, that a control role for the collaborative communication session is intended to be assigned to at least one terminal which is specified by the message as holder of a control role; and
assignment of a control role for the collaborative communication session to the at least one terminal which is specified by the message as holder of a control role.

2. The method as claimed in claim 1, wherein the message is received by a server in a communication system, and the control role is assigned by a server in the communication system.

3. The method as claimed in claim 2, wherein the communication system is a communication system designed in accordance with the Internet Protocol Multimedia Subsystem (IMS) of the 3GPP mobile radio standard.

4. The method as claimed in one of claims 1 to 3, wherein a plurality of terminals are specified by the message as holders of a control role.

5. The method as claimed in one of claims 1 to 4, wherein the message is a message in accordance with the Session Initiation Protocol (SIP).

6. The method as claimed in one of claims 1 to 5, wherein the at least one terminal which is specified by the message as the holder of a control role is specified in that it is a specifically identified one of a plurality of terminals indicated in the message.

7. The method as claimed in one of claims 1 to 6, furthermore having:
ending of a previously assigned control role for a terminal which is not specified by the message as a holder of a control role, for the collaborative communication session.

8. The method as claimed in one of claims 1 to 7, furthermore having:
ending of a previously assigned control role for a terminal which is indicated by the message as a terminal which should not have a control role for the collaborative communication session, for the collaborative communication session.

9. The method as claimed in one of claims 1 to 8, furthermore having:
transmission, before the assignment, of a request to a terminal which was previously assigned a control role for the collaborative communication session, as to whether the terminal which had previously been assigned a control role for the collaborative communication session authorizes the assignment.

10. A method for requesting a control role for a collaborative communication session, having:
transmission of a message which indicates, independently of a media transfer request for a collaborative communication session, that a control role for the collaborative communication session is intended to be assigned to at least one terminal which is specified by the message as holder of a control role.

11. The method as claimed in claim 10, wherein the message is transmitted by a terminal.

12. The method as claimed in claim 11, wherein the terminal which transmits the message is designed for access to a communication system, and the message is transmitted to a server in the communication system.

13. The method as claimed in one of claim 11 or 12, wherein the terminal which transmits the message is not specified by the message as the holder of a control role.

14. An apparatus for assignment of a control role for a collaborative communication session, having:
a receiving unit, designed to receive a message which indicates, independently of a media transfer request for a collaborative communication session, that a control role for the collaborative communication session is intended to be assigned to at least one terminal which is specified by the message as holder of a control role; and
an assignment unit, designed for assignment of a control role for the collaborative communication session to the at least one terminal which is specified by the message as holder of a control role.

15. The apparatus as claimed in claim 14, furthermore designed to carry out the method as claimed in one of claims 2 to 9.

16. An apparatus for requesting a control role for a collaborative communication session, having:
a request unit, designed for transmitting a message which indicates, independently of a media transfer request for a collaborative communication session, that a control role for the collaborative communication session is intended to be assigned to at least one terminal which is specified by the message as holder of a control role.

17. The apparatus as claimed in claim 16, furthermore designed to carry out the method as claimed in one of claims 11 to 13.
